(19) United States
(12) Patent Application Publication
(10) Pub. No.: US 2016/0344330 A1
(43) Pub. Date: Nov. 24, 2016

(54) Portable Solar Power System with Prefabricated Solar Racking

(71) Applicant: Dwayne H. Gillis, Douglas, GA (US)

(72) Inventor: Dwayne H. Gillis, Douglas, GA (US)

(21) Appl. No.: 15/160,703

(22) Filed: May 20, 2016

Related U.S. Application Data
(60) Provisional application No. 62/164,832, filed on May 21, 2015.

(51) Int. Cl. H02S 10/40; H02S 30/10; H02S 20/32; F16M 11/06

(52) U.S. Cl. CPC H02S 10/40; F16M 11/06; H02S 30/10; H02S 20/32

(57) ABSTRACT

A portable solar power system includes at least one prefabricated solar racking configured on a trailer frame that is transportable to a deployment site without oversize load travel restrictions (e.g., escort vehicles). The trailer frame includes one or more levelling members that permit a levelled installation of the trailer frame at the deployment site. A set of solar panels are attached to the at least one prefabricated solar racking. One or more extension members are coupled to the solar racking at the deployment site to receive and support additional sets of solar panels. The trailer frame accommodates one or more electrical and mechanical devices for harvesting solar energy, converting the solar energy to electrical energy, and/or transmitting the electrical energy to one or more loads.

### CROSS REFERENCE TO RELATED APPLICATION

This application claims priority to U.S. Provisional Application No. 62/164,832 filed on May 21, 2015 in the name of Dwayne H. Gillis and entitled ‘Prefabricated Solar Racking Module,’ the entire content of which is incorporated herein by reference.

### TECHNICAL FIELD

This disclosure relates generally to a technical field of renewable power systems, and more particularly to a portable solar power system with prefabricated solar racking.

### BACKGROUND

Solar power systems may include solar panel racking (solar racking) that may be used to fix solar panels on surfaces such as roofs, building facades, or the ground. Even though rooftop solar power systems are a common option, they are not always the best fit for some facilities. For example, facilities such as government agency buildings, schools, jails, etc., may have security concerns about providing uncleared individuals access to the roof of the facility for installation and/or other maintenance of the rooftop solar power system.

In lieu of the rooftop solar power systems, customers can use ground mounted solar power systems. However, in existing ground mounted solar power systems, the solar racking that supports the solar panels are permanently affixed to the ground and cannot be moved once installed, thereby locking up valuable real estate. That is, if for any reason, a customer wants to move the ground mounted solar power system to another location or decommission the ground mounted solar power system, there are no provisions to do so in existing ground mounted solar power systems. Further, in existing ground mounted solar power systems, the solar racking may be built on-site, i.e., the racking is put together piece-by-piece from scratch at a deployment site. Such piece-by-piece installation of the solar racking at the deployment site may require skilled labor which may be cost intensive. Further, the piece-by-piece installation may also be time intensive. Furthermore, in existing ground mounted power systems, the deployment site has to be graded to ensure a level base for deployment of the solar racking prior to installing or setting up the solar racking, which further increases the cost and time associated with installation.

Therefore, there is need for a solar power system and solar racking technology that overcomes the above mentioned deficiencies.

### SUMMARY

The present disclosure provides an improved portable solar power system that addresses one or more of the above mentioned deficiencies of the existing ground mounted solar power systems. In one example aspect, the portable solar power system of the present disclosure includes a prefabricated solar racking that is configured on a movable trailer for transportation to and from a deployment site and/or from one location to another location at the deployment site. Further, the trailer is provided with one or more levelling jacks that permits a level installation of the portable solar power system at the deployment site, thereby avoiding the need for site grading and traditional foundation work that is time intensive. In addition to permitting a level installation of the portable solar power system, the levelling jacks may also provide load bearing support for the portable solar power system at the deployment site.

In particular, the prefabricated solar racking of the portable solar power system includes one or more post members that are attached to and extend vertically upwards from a frame of the trailer (trailer frame or base frame). Further, the prefabricated solar racking includes one or more chord members, where each chord member is coupled to a top end of the one or more post members. The prefabricated solar racking may include purlins that are coupled to and disposed atop the one or more chord members such that they form a grid pattern with the one or more chord members. In particular, the size of the prefabricated solar racking, i.e., the lengths and widths of the chord members and the purlins, is restricted to the confines of the trailer frame or may extend only a short distance beyond the trailer frame, e.g., two feet or less, to meet the transportation restrictions and to avoid having to use escort vehicles for the transportation of the portable solar power system. Once the portable solar power system is at a deployment site, the prefabricated solar racking is extended by coupling one or more extension members, e.g., extension chord members and extension purlins, to the prefabricated solar racking. The one or more extension members may increase a surface area of the prefabricated solar racking to receive additional solar panels and thereby, increase a power output of the portable solar power system.

In certain example embodiments, the one or more extension members may be coupled to prefabricated solar racking at the factory, i.e., prior to transporting the portable solar power system to the deployment site. For example, the one or more extension members may telescope inside or slide underneath the prefabricated solar racking and upon full extension be pinned or bolted in place. That is, during transportation, the extension members may be retracted (slid in) to meet transportation restrictions, and upon arrival at the deployment site, the extension members may be pulled out (slid out) to a desired length and position. Then, pins or bolts may be used to lock the extension members in place for receiving the additional solar panels. In another example, the extension members may be coupled to the prefabricated solar racking using a hinge mechanism, where extension members may be partially attached to the prefabricated solar racking using pins, bolts, or hinges that would allow the extension members to swing down or up for transportation. Once at the deployment site, the extension members may be folded/extended out to its intended position, and locked in place using pins or bolts to receive the additional solar panels. However, in other example embodiments, the extension members may be transported detached from the prefabricated solar racking and once at the deployment site, the extension members may be attached to the prefabricated solar racking using metallic couplers and fasteners to receive the additional solar panels.

Further, in one example, the prefabricated solar racking may be stationary such that a tilt angle at which the solar panels are disposed is fixed once deployed. In another example, the prefabricated solar racking is rotatable about one or more axes to adjust a tilt angle at which the solar panels are disposed based on a position of the sun. That is, the portable solar power system is configured to track a position of the sun and rotate accordingly to maximize output and efficiency. If the extension members are attached to the prefabricated solar racking, then the extension members may also be rotated along with the prefabricated solar racking. For tiltable solar racking, the post members may be replaced by appropriate tracking and rotation mechanism, such as gear systems, hydraulic rams, etc.

The portable solar power system may include a single solar racking unit or multiple solar racking units that may be electrically connected to one another and operate in concert. The multiple solar racking units may include a fixed tilt solar racking and/or an solar racking with an adjustable tilt and/or tracking.

The foregoing discussion of the portable solar power system is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE FIGURES

Example embodiments are illustrated by way of example and not limitation in the figures of the accompanying drawings, in which:

FIG. 1 illustrates an end view of an example portable solar power system in an unextended state and without an outer frame of the trailer, in accordance with example embodiments of the present disclosure;

FIGS. 2A-2C (collectively ‘FIG. 2’) illustrate how some example members of the example portable solar power system illustrated in FIG. 1 are coupled to each other, in accordance with example embodiments of the present disclosure;

FIG. 3 illustrates an example trailer frame with removable wheels and axle for transportation and without a solar racking of the example portable solar power system illustrated in FIG. 1, in accordance with example embodiments of the present disclosure;

FIG. 4 illustrates the example trailer frame of FIG. 3 with the solar racking and without the removable wheels and axle, in accordance with example embodiments of the present disclosure;

FIG. 5 illustrates an example method of levelling and anchoring the example trailer frame illustrated in FIG. 3 at a deployment site, in accordance with example embodiments of the present disclosure;

FIG. 6 illustrates an overhead view of the example portable solar power system in an extended state with the solar panels on the prefabricated solar racking of FIG. 1 and the additional solar panels on extension members, in accordance with example embodiments of the present disclosure;

FIG. 7 illustrates an end view of the example portable solar power system illustrated in FIG. 1 in an extended state with the extension members and additional solar panels attached, in accordance with example embodiments of the present disclosure;

FIGS. 8A-8C (collectively ‘FIG. 8’) illustrate transportation and deployment of another example portable solar power system where the extension members are coupled to the prefabricated solar racking of FIG. 1 using hinges, in accordance with example embodiments of the present disclosure;

FIGS. 9A-9B (collectively ‘FIG. 9’) illustrate an end view and a top view of yet another example portable solar power system that is rotatable using a gear mechanism, in accordance with example embodiments of the present disclosure;

FIGS. 10A and 10B (collectively ‘FIG. 10’) illustrate another example portable solar power system that is rotatable using a hydraulic ram mechanism, in accordance with example embodiments of the present disclosure;

FIG. 11 illustrates another example portable solar power system that is rotatable and has a single post racking assembly, in accordance with example embodiments of the present disclosure; and

FIG. 12 illustrates an example portable solar power system that includes a fixed tilt portable solar power unit and a portable solar power unit with an adjustable tilt, in accordance with example embodiments of the present disclosure.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION OF THE EXAMPLE EMBODIMENTS

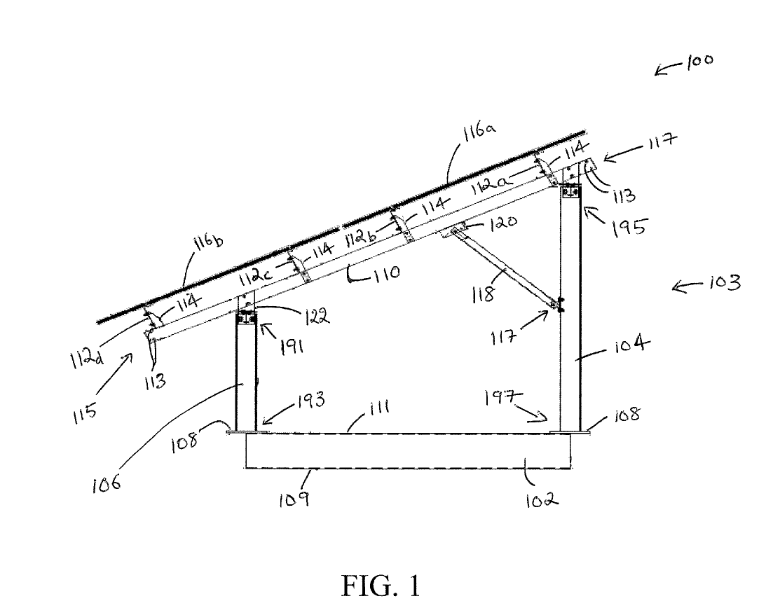

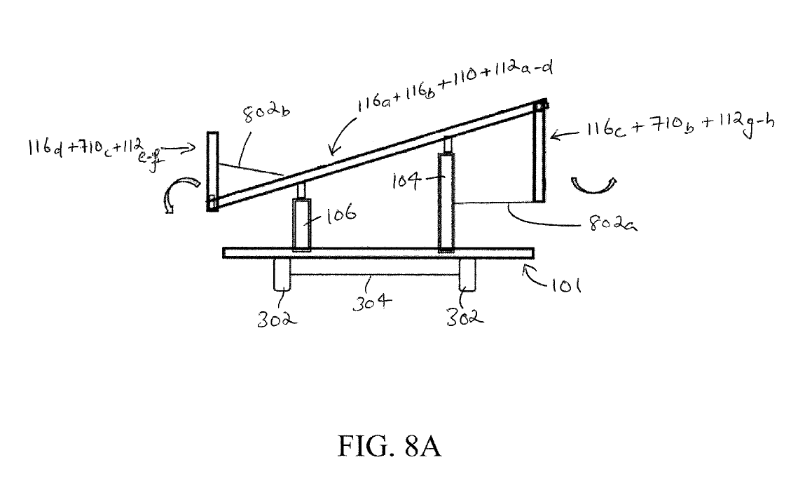

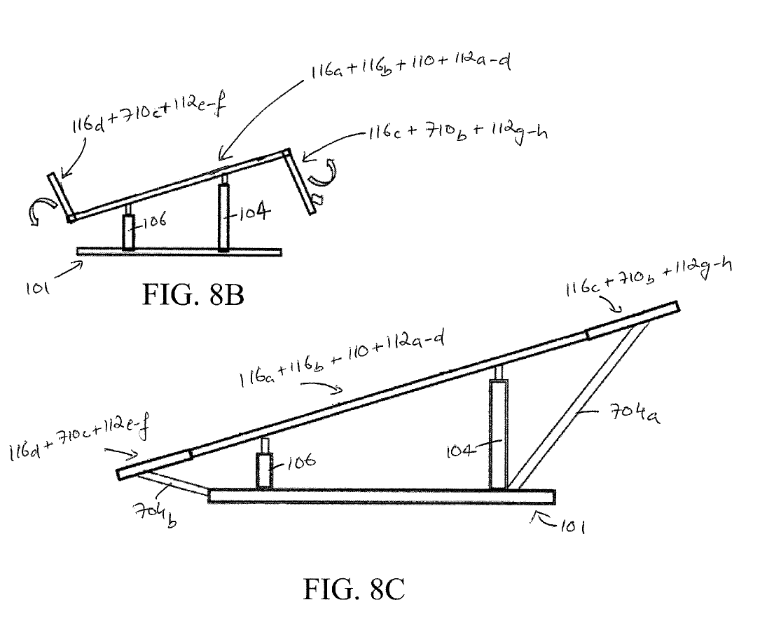

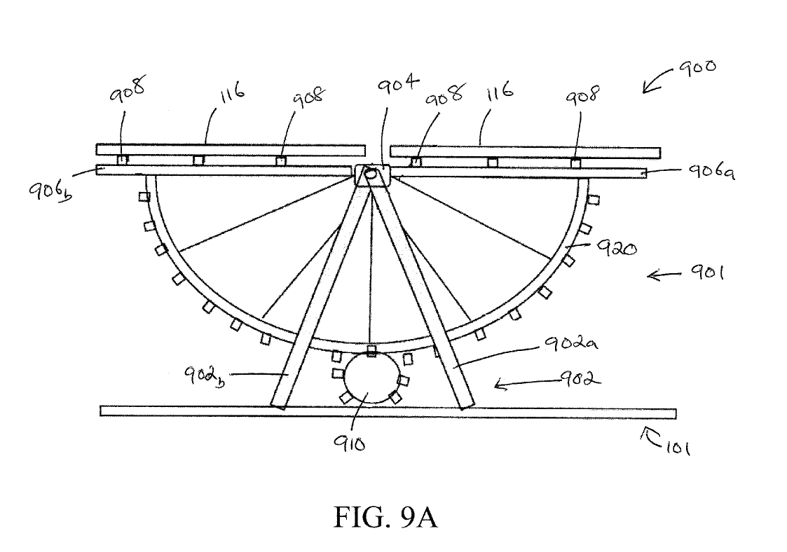

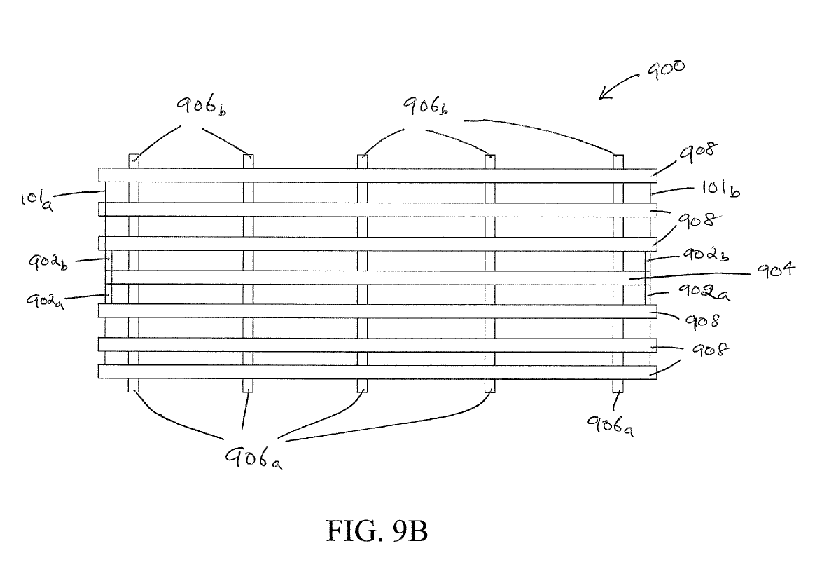

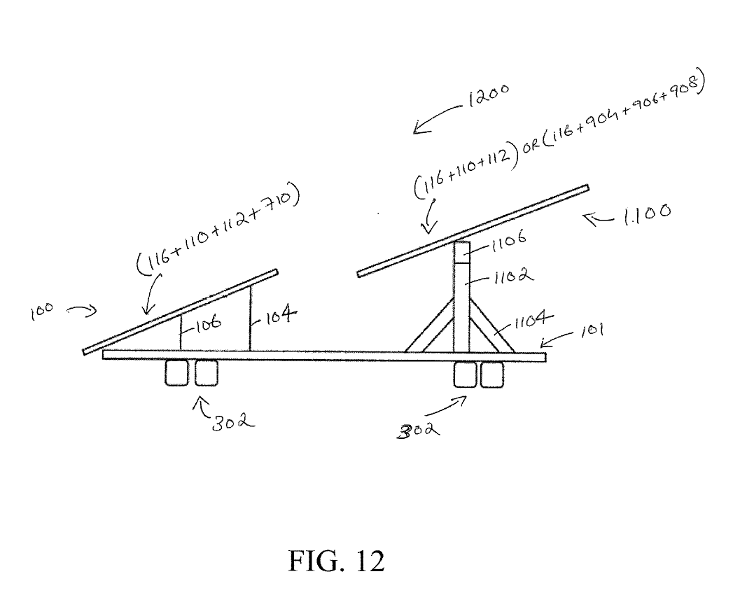

A portable solar power system will now be described in greater detail with reference to FIGS. 1-12, which illustrate representative embodiments of the present invention. FIGS. 1-7 illustrate one example portable solar power system using suitable illustrations; FIG. 8 illustrates another example portable solar power system with hinged extension members using suitable illustrations; FIGS. 9-11 illustrate different example portable solar power systems that are rotatable to adjust a tilt angle using suitable illustrations, and FIG. 12 illustrates a portable solar power system having a fixed tilt portable solar power system and a portable solar power system with an adjustable tilt.

In an example embodiment, the portable solar power system includes a prefabricated or factory installed solar racking that is configured on a trailer frame for transportation to a deployment site and harvesting solar energy at the deployment site (via solar panels installed on the solar racking). To permit transportation of the portable solar power system to a deployment site without the need for escort vehicles that are typically needed for oversize load transportation, the size (e.g., in length and width) of the prefabricated solar racking is restricted to substantially match the size of the trailer frame. the size of the prefabricated solar racking that is restricted for transportation may be extended at the deployment site by attaching one or more extension members to the prefabricated solar racking in order to receive and support additional solar panels, thereby, increasing a power output of the portable solar power system. The trailer frame of the portable solar power system is provided with one or more levelling jacks that permit level installation of the solar power system at the deployment site without the need for site grading or traditional foundation work.

In other words, the combination of the prefabricated solar racking, the trailer frame, and the extension members:
(a) reduces a transportation cost of the portable solar power system to and from the deployment site by permitting the portable solar power system to be transported without escort vehicles,
(b) reduces installation time and cost by factory installing a substantial portion of the solar racking and allowing easy levelling and deployment of the portable solar power system using the trailer jacks, and
(c) maximizes an output efficiency obtained per portable solar power system by allowing the portable solar power system to support additional solar panels through extension of the prefabricated solar racking at the deployment site.

That is, a customer can achieve efficient and cost-effective solar power generation by using the portable solar power system of the present disclosure. The efficiency of the portable solar power system is further increased in some embodiments by allowing a rotation of the solar racking (prefabricated and/or extension members) along one or more axes to adjust a tilt angle of the solar panels based on a position of the sun. Furthermore, in some example embodiments, multiple portable solar power units, both fixed tilt and adjustable tilt, may be used in combination to further increase the efficiency of the portable solar power system. One of ordinary skill in the art can understand and appreciate that the above mentioned advantages and features of the portable solar power system of the present disclosure are not limiting. That is, the portable solar power system of the present disclosure may have additional advantages and features that will become apparent from the following detailed description.

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention. In the following description, for purposes of explanation, numerous specific details are set forth in order to provide a thorough understanding of the various embodiments.

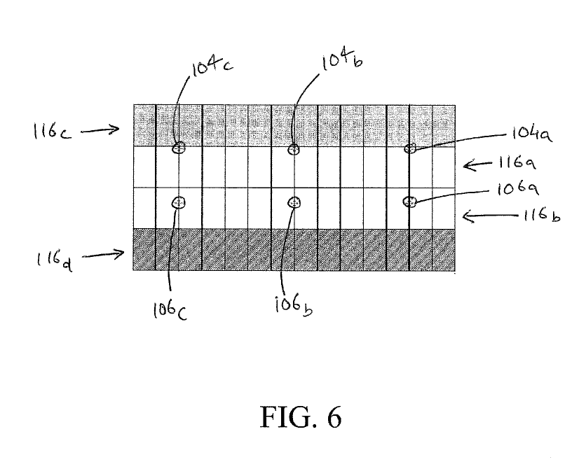

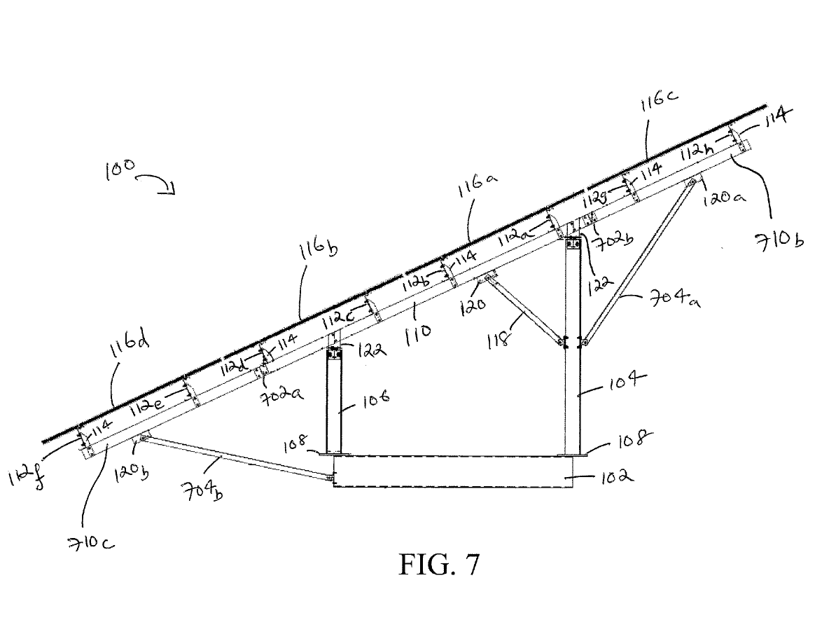

Referring now to FIGS. 1-4 and 6-7, these figures illustrate different views of one or more portions of an example portable solar power system in accordance with example embodiments of the present disclosure. In particular, FIGS. 1-4 illustrate at least a trailer frame 101, a prefabricated solar racking 103, and a set of solar panels 116. Further, FIGS. 6 and 7 additionally illustrate at least the extension members 710b-c and 112 e-h, and an additional set of solar panels 116c and 116d.

### Trailer Frame

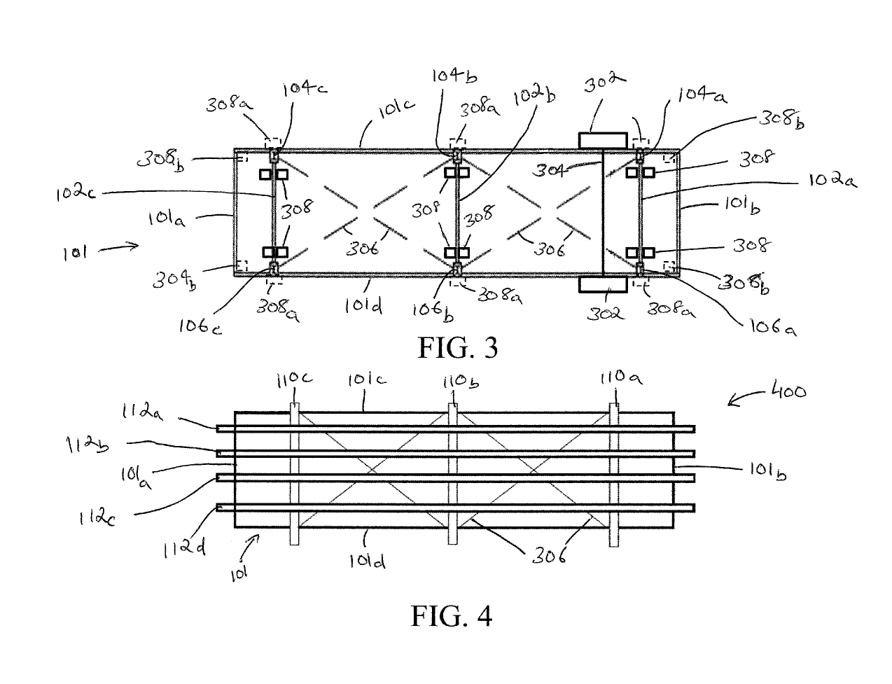

FIG. 3 illustrates an example trailer frame with removable wheels and axle for transportation and without a solar racking of the example portable solar power system illustrated in FIG. 1, in accordance with example embodiments of the present disclosure. As depicted in FIG. 3, the trailer frame 101 (herein interchangeably referred to as ‘base frame’) may include two lateral beams (101a, 101b) and the two longitudinal beams (101c, 101d) that are arranged such that they define a substantially rectangular shaped outer frame. Further, the trailer frame 101 may include three cross-member beams 102a-c for support, each of which is attached between the two longitudinal beams (101c, 101d) of the outer frame such that they are parallel to each other and to the two lateral beams (101a, 101b). In certain example embodiments, the lateral beams (101a, 101b), the longitudinal beams (101c, 101d), and the cross-member beams may be steel beams having an I-shaped cross sectional profile, however, in other example embodiments, beams of any other cross-sectional profile and material may be used without departing from a broader scope of the present disclosure.

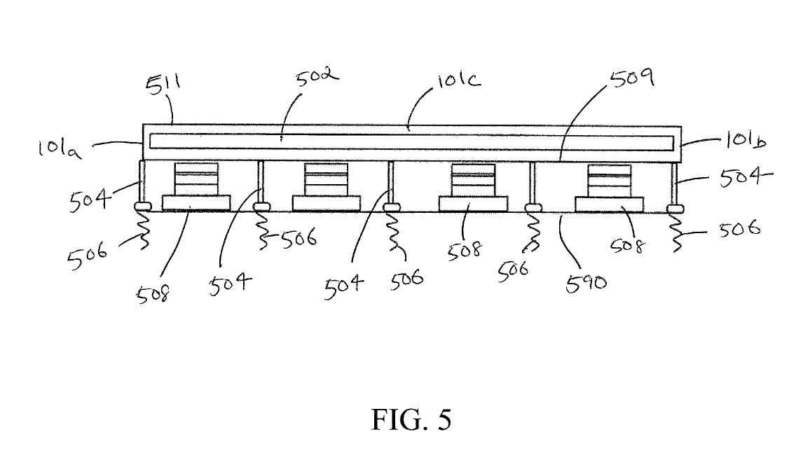

Furthermore, the trailer frame 101 may further include one or more diagonal support members 306 to provide additional support to the trailer frame 101 and to keep the trailer frame 101 from swaying. Each diagonal support member 306 may extend from a point of intersection of one end of a cross-member beam and a longitudinal beam 101c and a point of intersection of an opposite end of a neighboring cross-member beam and an opposite longitudinal beam 101d as illustrated in FIG. 3. In particular, the diagonal support members 306 may be attached to a bottom surface 109 (shown in FIG. 1) of the cross member beams (102a, 102b, 102c) and/or the bottom surface 509 (shown in FIG. 5) of the longitudinal beams (101c, 101d).

Additionally, the trailer frame may include a plurality of hand-cranked levelling jacks 308 (herein ‘levelling jacks’) that are configured to level the trailer frame 101. Further, the levelling jacks 308 may also be used to raise and lower the trailer frame 101 to be hitched or unhitched to and from a towing vehicle. Furthermore, in certain example embodiments, the levelling jacks 308 may also operate as a load bearing members for supporting the wind load and/or weight of the prefabricated solar racking 103, extension members 710b-c and 112e-h, and/or the solar panels 116a-d (shown in FIG. 7) mounted on the trailer frame 101 once the portable solar power system 100 is deployed at a site.

In one example, the levelling jacks 308 may be attached to the cross-member beams 102 of the trailer frame 101. For example, a pair of levelling jacks 308 may be attached to and disposed adjacent to each end of each cross-member 102a, 102b, and 102c as illustrated in FIG. 3. In particular, each levelling jack of the pair of levelling jacks 308 may be disposed on opposite sides of the cross member 102. However, in another example, the levelling jacks 308 may be attached to the rectangular shaped outer frame of the trailer frame 101. For example, trailer jacks 308b may be attached to each inner corner of the rectangular shaped outer frame. Alternatively, the trailer jacks 308a may be positioned adjacent each point of intersection of the cross-members 102 with the two longitudinal beams (101c, 101d) of the trailer frame 101.

It is noted that the referral numbers 308a and 308b marked by broken lines in FIG. 3 illustrate alternative positions for placement of the levelling jacks in addition to or instead of the levelling jacks 308 attached to and disposed adjacent each end of each cross-member 102a, 102b, and 102c. Further, one of ordinary skill in the art can understand and appreciate that the above included examples defining the position of the levelling jacks and the number of levelling jacks are not limiting. That is, in other example embodiments, the position of the levelling jacks and the number of levelling jacks may vary depending on the weight rating of the trailer jacks, a weight of the portable solar power system, the different loads (wind, snow, etc.) that are to be supported, and the shape and structure of the portable solar power system without departing from a broader scope of the present disclosure.

In certain example embodiments, the levelling jacks 308 may be permanently fixed to (e.g., welded to) and integrated with the trailer frame 101, whereas, in other example embodiments, the levelling jacks 308 may be temporary, detachable, and reusable jacks that may be removed and reused once the portable solar power system is set in place and levelled.

Further, as depicted in FIG. 3, the trailer frame 101 may include one or more sets of axles 304 and wheels 302 for transporting the portable solar power system to and from the deployment site and/or for moving the portable solar power system from one location to another at the deployment site. Additionally, for transportation, the trailer frame 101 may include a trailer tongue (not shown) and one or more lights (not shown) that are attached to the trailer frame 101. In particular, the one or more sets of axles 304, wheels 302, the trailer tongue, and the one or more lights may be detachable and reusable. That is, once the portable solar power system is transported to a desired deployment site, the one or more sets of axles 304, wheels 302, the trailer tongue, and the one or more lights may be detached and returned to the factory to be reused with another trailer frame of another portable solar power system. However, one of ordinary skill in the art can understand a appreciate that, in some embodiments, the wheels, their corresponding axles, and/or the trailer tongue may be permanently affixed to the trailer frame without departing from a broader scope of the present disclosure.

Furthermore, in certain example embodiments, the trailer frame 101 may include removable skids (not shown) and/or metal flooring (not shown) attached to the cross-member beams 102a-c. The metal flooring may have wood, metallic, or plastic tanks, boxes, or similar containers referred to as ballast boxes 502 (shown in FIG. 5) to hold sand, water, brick, cement, or similar heavy material as ballast. In particular, the ballast filled ballast boxes 502 may provide additional stability to the portable solar power system 100, for example, in high wind conditions.

Alternative to or in addition to the ballast boxes 502, additional stability may be provided to the trailer frame 101 by attaching the trailer frame 101 to the ground 590 using screws, pins, supports, anchors, chains, metallic straps, cables, or other securing devices. For example, as illustrated in FIG. 5, one or more ground screws or augers 506 may be drilled into the ground to a desired depth and metallic connectors, such as metallic strappings 504 may be used to firmly and securely attach the trailer frame 101 to the one or more ground screws or augers 506.

In certain example embodiments where the levelling jacks 308 are detachable, the trailer frame 101 (and thereby, the portable solar power system 100) may be set and levelled at the deployment site using a block and anchor method, where initially, one or more piles of cement blocks 508 are laid on the ground 590 and are brought up to the height (bottom surface 509) of the trailer frame 101. Then, the levelling jacks 308 are used to lower the trailer frame 101 onto the piles of concrete blocks 508 such that the trailer frame 101 rests on or is supported by the piles of concrete blocks 508. Then, final levelling adjustments may be made using wood shims and/or wedges. Thereafter, the levelling jacks 308 may be detached and returned to the factory (manufacturer) for reuse with another trailer frame 101 of another portable solar power system 100. Once the portable solar power system 100 is resting firmly on the one or more piles of concrete blocks 508, ground screws or augers 506 may be drilled into the ground to a desired depth and metallic connectors, such as metallic strappings 504, may be used to firmly and securely attach the trailer frame 101 to the one or more ground screws or augers 506, as described above. Lastly, ballast material may be added to the ballast boxes 502 of the trailer frame 101.

In other example embodiments where the levelling jacks 308 are permanently affixed, the trailer frame 101 (and thereby, the portable solar power system 100) may be set and levelled at the deployment site using a single block and levelling jack method, where one solid concrete block per levelling jack 308 is used as the foundation. Further, in the block and levelling jack method, the load bearing support for the trailer frame 101 is provided by the levelling jacks 308 instead of the piles of concrete blocks 508. In particular, first, a single concrete block per levelling jack 308 is placed on the ground 590, where each concrete block is placed such that it aligns with the respective levelling jack 308. Thereafter, the levelling jacks 308 are lowered down onto their respective concrete blocks such they rest on their respective concrete blocks, supporting weight load and wind load (or any other appropriate load). Additionally, in some embodiments, ground screws 506 and metal strapping 504 may be used to secure and attach the trailer frame 101 to the ground.

Even though the present disclosure describes the two setting and levelling methods as being used in separate scenarios, one of ordinary skill in the art can understand and appreciate that in some embodiments, both the setting and levelling methods may be used in combination with each other. That is, in some examples, the block and anchor method may be used in addition to the single block and levelling jack method. Further, even though the present disclosure describes a specific structure and shape of the trailer frame, one of ordinary skill in the art can understand that the trailer frame may have any other appropriate size or shape without departing from a broader scope of the present disclosure. For example, the trailer frame may have lesser or more number of cross-members. In another example, the trailer frame may have an additional support member disposed in between the two lateral beams (101a, 101b) and running parallel to the two longitudinal beams (101c, 101d). In another example, the rectangular shaped outer frame may be modified to have any other appropriate shape configured to accommodate various operations of the portable solar power system, such as tracking and tilt adjustment. Furthermore, even though the present disclosure describes a hand-cranked levelling jacks, one of ordinary skill in the art can understand and appreciate that, in other embodiments, any other appropriate type of levelling jacks may be used in addition to or instead of the hand-cranked levelling jacks without departing from a broader scope of the present disclosure.

In addition to the above mentioned features, the trailer frame 101 may further include steel tubes, supports, struts, braces, and/or other metallic fittings attached to the trailer frame 101 to receive and attach the prefabricated solar racking 103 to the trailer frame 101. The prefabricated solar racking 103 will be described in greater detail below in association with FIGS. 1, 2, 4, and 6.

Prefabricated Solar Racking

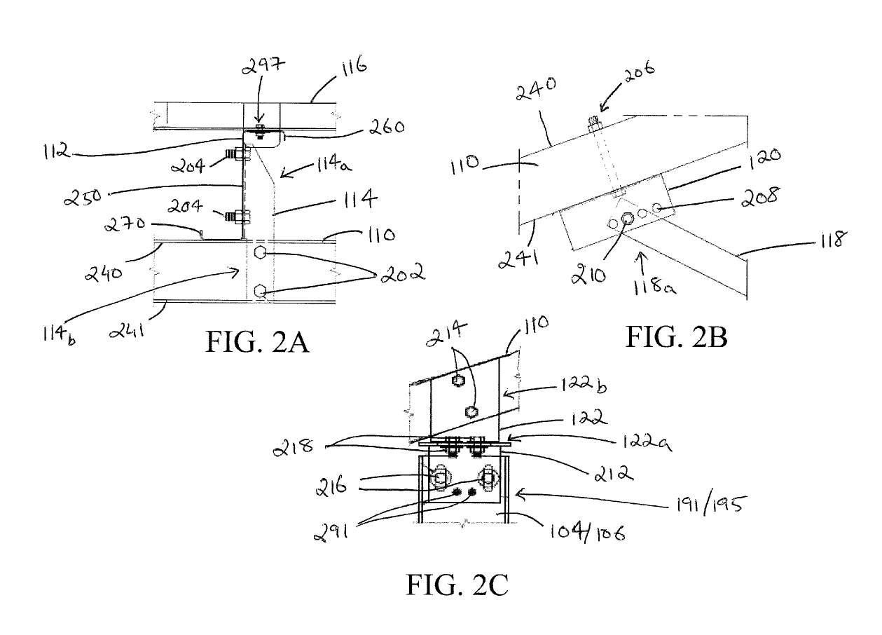

FIG. 1 illustrates an end view of an example portable solar power system in an unextended state and without an outer frame 101a-d of the trailer 101, in accordance with example embodiments of the present disclosure; FIGS. 2A-2C (collectively ‘FIG. 2’) illustrate how some example members of the example portable solar power system illustrated in FIG. 1 are coupled to each other, in accordance with example embodiments of the present disclosure; FIG. 4 illustrates the example trailer frame of FIG. 3 with the solar racking and without the removable wheels and axle, in accordance with example embodiments of the present disclosure; and FIG. 6 illustrates an overhead view of the example portable solar power system in an extended state with the solar panels on the prefabricated solar racking of FIG. 1 and the additional solar panels on extension members, in accordance with example embodiments of the present disclosure.

Referring now to FIGS. 1, 2, 4, and 6, the prefabricated solar racking 103 includes two sets of post members 104 and 106. Each set of post members 104 and 106 may include three post members 104a-c (interchangeably referred to as ‘post members 104’) and 106a-c (interchangeably referred to as ‘post members 104’), amounting to a total of six post members, as shown in FIG. 3 (top view of trailer frame with post members 104 and 106) and FIG. 6. However, one of ordinary skill in the art can understand and appreciate that in other example embodiments, lesser or more number of post members may be used without departing from a broader scope of the present disclosure.

Each post member (104, 106) may be attached to the trailer frame 101 and positioned at the intersections of the cross-member beams (102a, 102b, 102c) of the trailer frame 101 with the two longitudinal beams (101c, 101d) of the trailer frame 101. For example, the first set of post members (104a, 104b, and 104c) may be attached to the trailer frame 101 at the intersections of the cross-member beams (102a, 102b, and 102c) of the trailer frame 101 with the longitudinal beam 101c of the trailer frame 101. Similarly, the second set of post members (106a, 106b, and 106c) may be attached to the trailer frame 101 at the intersections of the cross-member beams (102a, 102b, 102c) of the trailer frame 101 with the opposite longitudinal beam 101d of the trailer frame 101. In particular, the post members 104 and/or 106 may be configured to transmit an updraft force and downward pressure (dead load, snow load, wind load, etc.) to the ground 590 via the longitudinal beams (101c, 101d), cross-member beams (102a-c), and the levelling jacks 308.

In certain example embodiments, each post member 104 and/or 106 may be a steel beam having an I-shaped cross-sectional profile. However, in other example embodiments, the post members 104 and 106 may be beams made of any other appropriate material and having any other appropriate cross-sectional profile without departing from a broader scope of the present disclosure. For example, the post members 104 and/or 106 may be an aluminum beam in some embodiments. In another example, the post members 104 and/or 106 may be U-shaped beams or steel tubes.

In particular, as depicted in FIG. 1, each post member 104 of the first set of post members may have a top end 195 and a bottom end 197. Similarly, each post member 106 of the second set of post members may have a top end 191 and a bottom end 193. The bottom ends (197 and 193) of each post member (104 and 106) may be attached (welded, bolted, etc.,) to the trailer frame 101 such that: (a) a portion of the bottom end 197 of the post member 104 is partially attached to the top surface 511 of the longitudinal beam 101c and a remainder portion of the bottom end 197 of the post member 104 is attached to the top surface 111 of a respective cross-member beam 102, and (b) a portion of the bottom end 193 of the post member 106 is partially attached to the top surface 511 of the longitudinal beam 101d (shown in FIG. 5) and a remainder portion of the bottom end 193 of the post member 106 is attached to the top surface 111 of a respective cross-member beam 102. As illustrated in FIG. 1, the bottom ends (193, 197) of each post member 104 and/or 106 may be attached to the trailer frame 101 via a respective metal plate 108 that is attached to a top surface of the trailer frame 101 at the at the intersections of the cross-member beams (102a, 102b, 102c) of the trailer frame 101 with the two longitudinal beams (101c, 101d) of the trailer frame 101. That is, a metal plate 108 may be disposed in between each post member 104 and/or 106 and the trailer frame 101.

Further, as illustrated in FIG. 1, each post member of the two sets of post members 104 and 106 may be vertically oriented and may extend upwards from the horizontally oriented trailer frame 101 such that the post members 104 and/or 106 are substantially perpendicular to the outer frame (101a-d) and the cross-member beams 102 of the trailer frame 101. In certain example embodiments, to provide additional support to the vertically oriented post members, wire ropes (not shown) may be attached between adjacent post members of the same set. For example, one wire rope may be attached between the top end 195 of post member 104a and the bottom end 197 of the adjacent post member 104b, and another wire rope may be attached between the top end 195 of post member 104b and the bottom end of post member 104a. Similarly, wire ropes may be attached between the post members 104b and 104c. Additionally, in some example embodiments, similar wire ropes may be attached between adjacent post members (106a, 106b) and (106b, 106c) of the second set of post members.

In certain example embodiments, each post member 104 of the first set of post members may be taller than each post member 106 of the second set of post members. However, all the post members of a given set (104 or 106) may have the same height (length). The height (length) of the post members 104 and 106 may be set based on a desired tilt angle at which the solar panels 116 are to be arranged in the portable solar power system. In particular, the tilt angle may be specific to the deployment site, e.g., based on a latitude of the deployment site location.

In addition to the post members 104 and/or 106, the prefabricated solar racking 103 may include a set of three chord members 110a, 110b, and 110c (shown in FIG. 4). However, in other example embodiments, the prefabricated solar racking may have lesser or more chord members without departing from a broader scope of the present disclosure.

As depicted in FIG. 1, each chord member 110 sits atop a pair of opposite post members, i.e., a post member 104 from the first set of post members and a post member 106 from the second set of post members. For example, the six post members 104a-c and 106a-c may form a three pairs of post members, i.e., a first pair of post members (104a, 106a), a second set of post members (104b, 106b), and a third set of post members (104c, 106c). Further, the first chord member 110a is attached to the top ends 195, 191 of the first pair of post members (104a, 106a), the second chord member 110b is attached to the top ends 195, 191 of the second pair of post members (104b, 106b), and the third chord member 110c is attached to the top ends 195, 191 of the third pair of post members (104c, 106c).

In particular, the chord members 110a-c are attached atop the post members 104 and 106 such that the chord members 110a-c are parallel to each other and each chord member is substantially perpendicular to a longitudinal length of the trailer frame (or the longitudinal beams (101c, 101d) of the trailer frame 101). Further, as illustrated in FIGS. 1 and 4, the length of each chord member 110a-c may span the width of the trailer frame (distance between longitudinal beams (101c, 101d)) or slightly extend beyond the width of the trailer frame 101. In some example embodiments, the chord members 110a-c of the prefabricated solar racking 103 may cantilever towards the side of one post member, e.g., post member 106 as shown in FIG. 1, while in other example embodiments, the chord members 110a-c may cantilever towards the side of the opposite post member, e.g., post member 104 without departing from a broader scope of the present disclosure. Further, as illustrated at least in FIG. 1, the chord members 110a-c may be attached atop the post members 104 and 106 such that they are inclined at an angle (acute internal angle/obtuse external angle) with respect to the ground 590 or the horizontally oriented trailer frame 101. As described above, the inclination angle of the chord members 110a-c may depend on the heights (lengths) of the post members 104 and 106 to which the chord members 110a-c are attached.

In certain example embodiments, each chord member 110 may be a single piece of steel tube that has a square or rectangular cross-sectional profile and longitudinally spans the width of the trailer frame or extends slightly beyond the width of the trailer frame 101. However, in other example embodiments, the chord members 110 may have any other shape and/or length or may be formed using any other appropriate material without departing from a broader scope of the present disclosure.

As illustrated in FIG. 2C, each chord member 110a may be coupled to the top end 191 or 195 of a post member 104 or 106 using a pair of brackets, e.g. post mounting bracket 212 and a chord mounting bracket 122. In particular, the post mounting bracket 212 may include a first portion that is horizontally oriented and a second portion that is disposed below the first portion and is substantially perpendicular to the first portion. The second portion of the post mounting bracket 212 may be coupled to the top end (195 or 191) of the post member (104 or 106) using one or more fasteners, such as screws 291 and/or nut and bolt pairs 216. The chord mounting bracket 122 may be substantially U-shaped mounting bracket having a planar base portion 122a and two arms 122b that extend substantially perpendicular to the planar base portion 122a from opposite ends of the planar base portion 122a. In particular, the two arms 122b of the chord mounting bracket 122 may be coupled to the chord member 110 using one or more fasteners, such as screws and/or nut and bolt pairs 214. Further, to couple the chord member 110 to the top end (195 or 191) of the post member (104 or 106), the planar base portion 122a of the chord mounting bracket 122 may be placed on the first horizontally oriented portion of the post mounting bracket 212 such that mounting apertures in the planar base portion 122a of the chord mounting bracket 122 align with the mounting apertures in the first horizontally oriented portion of the post mounting bracket 212 to receive fasteners. Thereafter, fasteners, such as screws and/or nut and bolt pairs 218, may be passed through the aligned mounting apertures of the chord mounting bracket 122 and the post mounting bracket 212 to couple the chord member 110 to the post member 104 or 106. In other example embodiments, any other appropriate coupling mechanisms may be used to attach the chord members to the post members without departing from a broader scope of the present disclosure.

Referring back to FIG. 1, the prefabricated solar racking 103 may further include a knee bracing member 118 that is attached between each post member 104a-c of the first set of post members and the respective chord members 110a-c attached to the first set of post members 104a-c for providing additional lateral support to the chord members 110a-c. In particular, as illustrated in FIGS. 1 and 2B, one end of each knee bracing member 118 may be attached to a post member 104 via a bracket 117 and the opposite end 118a of the knee bracing member 118 may be attached to a knee bracing clip 120 that is in turn attached to the bottom surface 241 of the chord member 110 using fasteners 206 that run through the knee bracing clip 120 and the top and bottom surfaces (240, 241) of the chord member 110. The knee bracing clip 120 may include one or more mounting holes 208, one of which may be aligned with a coupling hole on the opposite end 118a of the knee bracing member 118 as illustrated in FIG. 2B. Further, fasteners, such as screws or nut and bolt pairs 210 may be passed through the aligned holes of the knee bracing clip 120 and the knee bracing member 118 to attach the knee bracing member 118 to the chord member 110.

Even though the present disclosure describes the prefabricated solar racking as having one knee bracing member 118 per chord member 110a-c, one of ordinary skill in the art can understand and appreciate that additional knee bracing support members may be provided at any appropriate location to provide additional support to the chord members 110a-c without departing from a broader scope of the present disclosure. Further, even though the present disclosure describes using a knee bracing clip 120 for coupling the knee bracing member 118 to the chord member 110, one of ordinary skill in the art can understand and appreciate that any other coupling mechanism may be used without departing from a broader scope of the present disclosure. Furthermore, in some example embodiments, the chord members may not need any additional lateral support.

Referring to FIGS. 1 and 4, the prefabricated solar racking 103 may further include a plurality of purlins 112a-d that are attached on top of the chord members 110a-c. In particular, each purlin 112a-d may be a single Z-shaped beam that extends across all the chord members, e.g., three chord members 110a-c of the prefabricated solar racking 103 and spans or extends slightly beyond the length (distance between lateral beams (101a, 101b)) of the trailer frame 101 as illustrated in FIG. 4. As illustrated in FIG. 2A, each purlin 112 may have a middle portion 250 and two arms 260 and 270 that extend substantially perpendicular to the middle portion 250 in opposite directions from opposite ends of the middle portion 250 defining a Z-shaped cross-section.

Further, as illustrated in FIGS. 1 and 4, the purlins 112a-d may be attached atop the chord members 110a-c such that: (a) the purlins 112a-d run parallel to each other and the longitudinal beams (101c, 101d) of the trailer frame 101, and (b) the purlins 112a-d form a grid pattern with the chord members 110a-c. Furthermore, as illustrated in FIG. 1, the plurality of purlins 112a-d may be configured to receive and securely retain solar panels 116a-b atop the plurality of purlins 112a-d. In certain example embodiments, these solar panels 116a-b may be attached to the purlins 112 at the factory, whereas, in other example embodiments, the solar panels 116a-b may be attached to the purlins 112 at the deployment site. In particular, the space between the purlins 112a-d may be set based on a size specification of the solar panels 116a-b and/or to match the size of solar panels 116a-b. For example, in FIG. 1, the purlins 112a-d are spaced apart such that they can accommodate two rows of the solar panels 116a and 116b, each solar panel 116a and 116b being attached to two purlins (112a, 112b) and (112c, 112d), respectively. Each purlin 112a-d may have holes that are precision drilled to match/align with mounting holes of the specific solar panels 116a-b.

As illustrated in FIG. 2A each purlin 112 may be attached to a chord member 110 using a purlin mounting bracket 114. In particular, the purlin mounting bracket 114 may be coupled to the chord member 110 by attaching a bottom portion 114b of the purlin mounting bracket 114 to the chord member 110 using one or more fasteners, such as nuts 202 that extend through the side surfaces of the chord member 110. Further, one or more nuts may be used to attach to the bolt and thereby securely attach the purlin mounting bracket 114 to the chord member 110. Further, the purlin mounting bracket 114 may be coupled to the purlin 112 by disposing a top portion 114a of the purlin mounting bracket 114 against the middle portion 250 of the purlin 112 such that coupling apertures in the middle portion 250 of the purlin 112 aligns with the coupling apertures in the top portion 114a of the purlin mounting bracket 114. Thereafter, fasteners, such as nut and bolt pairs 204 may be passed through the aligned coupling apertures of the purlin 112 and the purlin mounting bracket 114 to couple the purlin 112 to the purlin mounting bracket 114, and thereby, to the chord 110. Furthermore, as illustrated in FIG. 2A, a bottom arm 270 of the purlin 112 may be disposed on the top surface 240 of the chord 110.

Additionally, as illustrated in FIG. 2A, the solar panel 116 is disposed on and secured/attached to the top arm 260 of the purlin 112 using one or more fasteners, such as nut and bolt pairs 297. In particular, the mounting holes on the solar panel 116 may be aligned with the precision drilled coupling holes on the top arm 260 of the purlin. Bolts are then used to attach the solar panels 116 to the purlins 112 by passing the bolts through the aligned holes of the solar panels 116 and the purlin 112. Also, washer and/or nuts are used and attach to the bolt. In certain example embodiments, the nut may have a special flange with grooves in it. As the nut is tightened, it contacts the purlins 112, e.g., digs into and scratches into the purlins 112. This contact, e.g., digging and scratching action, electrically grounds the solar panel 116 to the prefabricated solar racking 103. Further, a grounding wire and/or rod may be used to ground the prefabricated solar racking 103.

Even though the present disclosure describes the purlins as being Z-shaped beams that span at least the length of the trailer frame 101, one of ordinary skill in the art can understand and appreciate that, in other example embodiments, the purlins may have any other appropriate shape and/or length without departing from a broader scope of the present disclosure. Furthermore, even though the present disclosure illustrates two rows of solar panels supported by the purlins 112a-d of the prefabricated solar racking 103, one of ordinary skill in the art can understand and appreciate that, in other example embodiments, the purlins 112 and chords 110 may be arranged such that lesser or more number of solar panel rows may be supported by the prefabricated solar racking 103 (i.e., without the extension members). Further, in other example embodiments, smaller or larger solar panels 116 may be used in combination with lesser or more purlins 112 having different spacing between each other without departing from a broader scope of the present disclosure.

In one example embodiment, as illustrated in FIG. 6, the prefabricated solar racking 103 of FIG. 4 may support two rows 116a and 116b of fourteen solar panels, totaling twenty eight solar panels without the extension members 710b-c and 112e-h (shown in FIG. 7). That is, in said example embodiment, to meet transportation restrictions, the portable solar power system 100a may be transported to the deployment site with the prefabricated solar racking 103 and/or the twenty eight solar panels 116a-b. However, once at the deployment site, the prefabricated solar racking 103 may be extended using one or more extension members 710b-c and 112e-h to support additional rows of solar panels 116c-d as illustrated by the shaded portion of FIG. 6. Similar to the prefabricated solar racking 103, the extension members 710b-c and 112e-h may support fourteen solar panels in each additional row 116c-d, i.e., a total of twenty eight additional solar panels, and a grand total of fifty six solar panels with the solar panels 116a-d supported by the prefabricated solar racking 103. In other words, in the example embodiment illustrated in FIG. 6, the total number of solar panels that can be supported by the portable solar power system doubles when the extension members 710b-c and 112e-h are attached. However, in some example embodiments the total number of solar panels that can be supported by the portable solar power system may even triple with the addition of additional extension members.

Even though the example embodiment of FIG. 6 illustrates a portable solar power system that supports a grand total of fifty six solar panels, one of ordinary skill in the art can understand and appreciate that in other example embodiments, lesser or more number of solar panels may be supported by the portable solar power system without departing from a broader scope of the present disclosure. For example, in some example embodiments, the size and structure of the solar racking (prefabricated plus the extension members) may be modified to support lesser number of solar panels, e.g., thirty six solar panels. Alternatively, in other example embodiment, the size and structure of the solar racking (prefabricated plus the extension members) may be modified to support more number of solar panels, e.g., fifty six or even seventy two solar panels. In either case, the ability to attach additional solar panels to a portable solar power system via extension member significantly increases the power output of the portable solar power system.

In particular, the prefabricated solar racking 103 that is affixed to the trailer frame 101 in the factory reduces an installation time of the portable solar panel system at the deployment site to a time taken to install the extension members and the additional solar panels as opposed to installing the whole racking structure from scratch as in the case of existing ground mounted solar power systems. In one example, upon request for a portable solar power system, removable wheels 302, axles 304, signal lights, and a trailer tongue may be attached to the trailer frame 101 in the factory. Thereafter, the prefabricated solar racking 103 that is affixed to the trailer frame 101 may be transported from the factory to the deployment site by a motorized vehicle (e.g., heavy-duty pick-up truck). The size of the prefabricated solar racking 103 that leaves the factory may be substantially similar to that shown in FIG. 4. That is, the prefabricated solar racking 103 may not extend substantially beyond the size, i.e., the width and length, of the trailer frame 101. Therefore, the transportation of the prefabricated solar racking 103 to the deployment site may not require escort vehicles even though the prefabricated solar racking 103 may be classified as an oversize load.

Upon arrival at the deployment site, the trailer frame 101 may parked at a desired location. Then, the set-up crew may detach the removable wheels, axles, signal lights, and/or trailer tongue to be returned to the factory for reuse with trailer frames of other portable solar power systems. Further, the set-up crew may level the trailer frame on the ground using the single block and levelling jack method and/or the block and anchor method as described above. The levelling jacks and/or the block and anchor method described above for set-up of the portable solar power system eliminates the need for traditional foundation work and site grading, thereby, further reducing the installation time of the portable solar power system as compared to existing ground mounted solar power systems. Responsive to levelling the trailer frame 101, the set-up crew may fill the ballast boxes 502 of the trailer frame 101 with ballast material to provided added stability to the portable solar power racking to withstand wind load and/or the weight of racking and the solar panels.

In particular, the prefabricated solar racking 103 may be designed to withstand wind speeds of 90-115 miles per hour, depending upon the wind zone destination. The metal strappings, the ballast, and/or additional securing mechanisms may further increase the ability of portable solar power system to withstand strong winds or other factors that affect the stability of the portable solar power system.

Lastly, once the portable solar power system is levelled and securely attached to the ground, extension members may be attached to the prefabricated solar racking 103 to receive additional solar panels. The extension members and the process of extending the prefabricated solar racking 103 may be further described in greater detail below in association with FIG. 7.

### Extension Members and Extension of Prefabricated Solar Racking

FIG. 7 illustrates an end view of the example portable solar power system illustrated in FIG. 1 in an extended state with the extension members and additional solar panels attached, in accordance with example embodiments of the present disclosure. Referring to FIG. 7, the extension members may include two sets of three extension chord members, i.e., a first set of three extension chord members 710b and a second set of three extension chord members 710c. Further, the extension members may include four extension purlins 112e-h. Even though the present disclosure describes the extension members as including six extension chord members and four extension purlins, one of ordinary skill in the art can understand and appreciate that in other example embodiments, lesser or more extension chord members and extension purlins may be used without departing from a broader scope of the present disclosure. Further, one of ordinary skill in the art can understand and appreciate that in some example embodiments, the extension members may include other types of members in addition to or in place of the extension chord members and/or the extension purlins without departing from a broader scope of the present disclosure.

Each extension chord member 710 may be configured to attach to a respective chord member (110a-c) of the prefabricated solar racking 103 to extend a length of each chord member 110 of the prefabricated solar racking 103. In particular, as illustrated in FIG. 1, each chord member 110a-c of the prefabricated solar racking 103 may include extension coupling holes 113 positioned adjacent a proximal end 115 and a distal end 117 of the respective chord member to assist with attaching the extension chord members 710. In certain example embodiments, as illustrated in FIG. 7, each extension chord member of the first set of extension chord members 710b may be configured to attach to the distal end 117 of a respective chord member 110 of the prefabricated solar racking 103. Similarly, each extension chord member of the second set of extension chord members 710c may be configured to attach to the proximal end 115 of a respective chord member 110 of the prefabricated solar racking 103. Accordingly, the length of each chord member 110a-c of the prefabricated solar racking 103 may be extended in opposite directions by attaching the extension chord members 710a and 710b.

Even though the present disclosure describes the one extension chord member 710 being attached to either end of a chord member 110 of the prefabricated solar racking, one of ordinary skill in the art can understand and appreciate that in other example embodiments, more than one extension chord members may be attached to either end of the chord member of the prefabricated solar racking (herein ‘prefabricated chord member’) without departing from a broader scope of the disclosure. The number of extension chord members that may be attached to either end of a prefabricated chord member may depend upon a tilt angle, ground clearance, and weight supporting capacity of the prefabricated solar racking and/or the levelling jacks.

In one example, more than one extension chord members 710 may be attached to a distal end 117 of the prefabricated chord member 110 such that the prefabricated chord member 110 extends towards the distal end 117. However, in another example, more than one extension chord member 710 may be attached to a proximal end 115 of the prefabricated chord member 110 such that the prefabricated chord member 110 extends towards the proximal end 115. A stability of the portable solar power system 100 may also be taken into consideration while determining the number of extension chord members 710 that may be added to either ends of the prefabricated chord member 110. Further, even though FIG. 7 illustrates the extension chord members 710 as being half the size of the prefabricated chords members 110, one of ordinary skill in the art can understand and appreciate that in other example embodiments, the extension chord members 710 may be shorter or longer than that illustrated in FIG. 7 without departing from a broader scope of the present disclosure.

In the example embodiment of FIG. 7, the extension chord members 710b and 710c may be attached to a distal end 117 and the proximal end 115 of each prefabricated chord member 110 using metallic couplers, such as splice plates 702a and 702b. In particular, an end of the extension chord member 710b having extension coupling holes may be placed end-to-end with the distal end 117 of a prefabricated chord member 110. Further, a splice plate 702b may be placed over the joint such that coupling apertures of the splice plate 702b may be aligned with the extension coupling holes of the extension chord member 710b and the coupling holes 113 of the prefabricated chord member 110. Lastly, the extension chord member 710b and the prefabricated solar racking chord member 110 may be joined together using one or more fasteners, such as screws and/or nuts and bolt pairs that are passed through the splice plate 702b, the extension chord member 710b, and the prefabricated solar racking chord member 110. Further, the extension chord member 710a may be attached to a proximal end 115 of the prefabricated chord member 110 in a similar manner and thus, will not be repeated herein for sake of brevity.

Furthermore, as illustrated in FIG. 7, additional lateral support may be provided for each extension chord member 710b and 710c using knee bracing members 704a and 704b, respectively. In particular, as illustrated in the example embodiment of FIG. 7, the knee bracing member 704a may be attached between the post member 104 and the extension chord member 710b; and the knee bracing member 704b may be attached between the trailer frame 101, e.g., cross-member beam 102 and the extension chord member 710c. The knee bracing members 704a and 704b may be coupled to the extension chord members 710b and 710c and the post members 104/106 or the trailer frame 101 using knee bracing clips 120a and 120b and other post mounting brackets or trailer mounting brackets as described above in association with FIGS. 1 and 2B. Accordingly, the description related to coupling of the knee bracing members 704a and 704b with the extension chord members 710b and 710c, respectively, will not be repeated herein for sake of brevity.

As described above and as illustrated in the example embodiment of FIG. 7, the extension members may further include four extension purlins 112e-h, two (112e-f) of which are attached atop the extension chord member 710c on the proximal end 115 of the prefabricated chord 110 and the other two (112g-h) attached atop the extension chord member 710b on the distal end 117 of the prefabricated chord 110. Once the extension purlins 112e-h are attached to the extension chord members 710b-c, additional rows of solar panels 116c and 116d may be attached to the extension purlins 112e-h. For example, the row of solar panels 116c may be attached to the extension purlins 112g-h and the row of solar panels 116d may be attached to the extension purlins 112e-f. In particular, the extension purlins 112e-h may be coupled to the extension chord members 710b-c using purlin mounting brackets 114 as described above in association with FIGS. 1 and 2A. Similarly, the additional rows of solar panels 116c-d may be attached to the extension purlins 112e-h as described above in association with FIGS. 1 and 2A. Accordingly, the description related to the attachment of the additional rows of solar panels 116c-d to the extension purlins 112e-h, and the attachment of the extension purlins 112e-h to the extension chords 710b-c will not be repeated herein for sake of brevity.

Even though the present disclosure describes extending a width of the prefabricated solar racking 103, i.e., the length of the chord members 110, one of ordinary skill in the art can understand and appreciate that in other example embodiments, the prefabricated solar racking may be extended in any direction without departing from a broader scope of the present disclosure. For example, the length of the prefabricated solar racking 103, i.e., the length of the purlin members 112 may be extended by attaching extension purlin members on opposite ends of each purlin 112a-d of the prefabricated racking 103. Alternatively or in addition to extending the length and width of the prefabricated solar racking 103, in some example embodiments, the prefabricated racking 103 may also be extended diagonally.

Further, even though the present disclosure describes the purlins 112a-d as extending slightly beyond the length of the trailer frame 101, one of ordinary skill in the art can understand and appreciate that, in some example embodiments, each purlin 112a-d may be significantly longer than the length of the trailer frame 101. For example, the purlins 112a-d may be six to eight feet longer than the outer pair of post members (104a, 106a) and (104c, 106c). These longer purlins may or may not need additional support bracing, such as knee bracing. The longer purlins may provide additional surface area for attached additional solar panels.

Furthermore, the shape of the extension chord members and the extension purlins may substantially match the shape of the chord members and purlins of the prefabricated solar racking 103 as described above in association with FIG. 1. However, in other example embodiments, the shape of the extension chord members and the extension purlins may differ from the shape of the prefabricated solar racking chord members and purlins without departing from a broader scope of the present disclosure.

In particular, in the example embodiment of FIG. 7, the extension members 710b-c, 112e-h, and/or 704a-b may be transported detached from the prefabricated solar racking 103 to meet the transportation restrictions. Once at the deployment site, the extension members 710b-c, 112e-h, and/or 704a-b may be attached to the prefabricated solar racking 103. However, in other example embodiments, the extension members 710b-c and 112e-h may be attached to the prefabricated solar racking 103 in the factory. That is, in said other example embodiments, the prefabricated solar racking 103 may be transported to the deployment site with the extension members 710b-c and 112e-h being attached to the prefabricated solar racking 103, but in a retracted or unextended state to avoid the need for escort vehicles. In said example embodiments, once at the deployment site, the retracted extension members 710b-c and 112e-h may be extended out and firmly secured in place. Such example embodiments where the prefabricated solar racking 103 may be transported to the deployment site with the extension members 710b-c and 112e-h being attached will be described in greater detail below in association with FIG. 8.

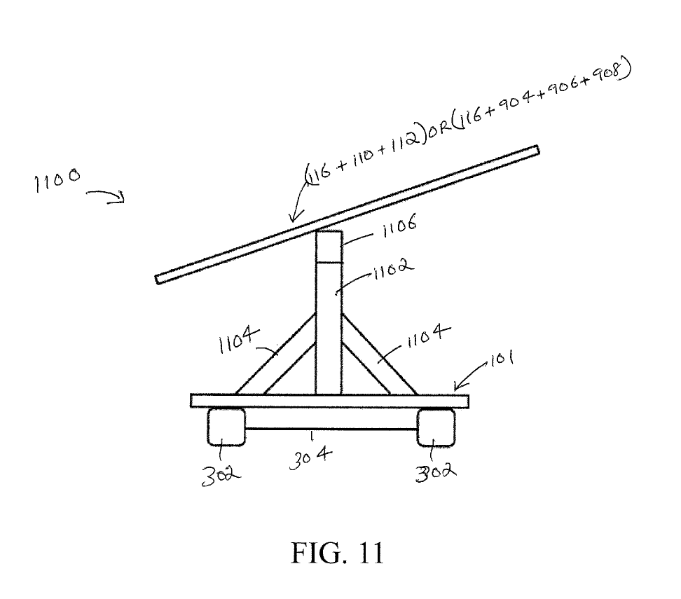

Turning to FIG. 8, this figure illustrates transportation and deployment of another example portable solar power system where the extension members are coupled to the prefabricated solar racking of FIG. 1 using hinges, in accordance with example embodiments of the present disclosure. In particular, the illustration of one or more structures of the portable solar power system, such as the prefabricated solar racking and the extension members have been simplified for clarity. For example, the chord members, the purlins, and the solar panels of the prefabricated solar racking are combined and shown as one member; and similarly, the extension chord members, extension purlins, and the additional solar panels are combined and shown as members on either ends of the prefabricated solar racking. However, one of ordinary skill in the art can understand and appreciate that the chord members, the purlins, and the solar panels of the prefabricated solar racking; and the extension chord members, extension purlins, and the additional solar panels are separate members that are attached to each other as in FIGS. 1 and 7 and have been simplified in FIG. 8 for clarity. Similar approach has been taken in FIGS. 11 and 12, i.e., the illustration of one or more structures of the portable solar power system have been simplified for clarity.

Referring to FIG. 8, in one example embodiment, the extension members 710b-c and 112e-h may be attached to the prefabricated solar racking 103 using a hinge mechanism that allows the extension members 710b-c and 112e-h to be folded in or retracted during transportation and folded out or extended once at the deployment site. In particular, for transportation, the extension chord members 710c-d may be partially attached to the prefabricated chord members 110a-c using a hinge or a functionally similar device that allows the extension chord members 710c-d (with the attached extension purlins 112e-h) to swing down or up. However, the extension purlins 112e-h may be securely attached to the extension chord members 710c-d. As illustrated in FIG. 8A, the swinging extension chord members 710c-d (with the attached extension purlins 112e-h) may be folded down or up and secured to the prefabricated solar racking 103 using one or more securing members (802a, 802b), such as locks, bolts, chains, straps, pins, or functionally similar elements. Upon reaching the deployment site, the folded extension chord members 710c-d (with the attached extension purlins 112e-h) may be unsecured by removing the one or more securing members (802a, 802b). Further, as illustrated in FIGS. 8B and 8C, the folded extension chord members 710c-d (with the attached extension purlins 112e-h) may be extended out (folded out) to its intended position and locked in place by the use of pins or bolts. Furthermore, as illustrated in FIG. 8C and as described above in association with FIG. 7, knee bracing members may be attached between the extension members and the trailer frame or post members to provide additional lateral support to the extension members. Thereafter, the additional solar panels 116c-d may be attached to the extension purlins 112e-h as described above in association with FIG. 7. However, it is noted that the hinge method of attaching the extension members 710-b-c and 112e-h described above allows for the additional solar panels to be attached to the extension purlins 112e-h in the factory, if desired. In some example embodiments, the extension chord members 710 may be transported without the extension purlins 112e-h being attached thereto. Accordingly, after extension or folding out the extension chord members 710, the extension purlins 112e-h may be attached to the extension chords 710 prior to mounting the additional solar panels 116c-d.

Even though the present disclosure describes attaching the extension members 710b-c and 112e-h to the prefabricated solar racking 103 using a hinge mechanism as illustrated in FIG. 8 or using metallic couplers as illustrated in FIG. 7, one of ordinary skill in the art can understand and appreciate that in other example embodiments, the extension members 710b-c and 112e-h may be attached to the prefabricated solar racking 103 using any other appropriate mechanism without departing from a broader scope of the present disclosure. For example, in some embodiments, the extension members 710b-c and/or 112e-h may telescope inside one or more members of the prefabricated solar racking 103 for transportation. Alternatively, the extension members 710b-c and/or 112e-h may slide-in and under the chord and purlin members of the prefabricated solar racking 103 for transportation. Upon arrival at the deployment site, the extension members 710b-c and/or 112e-h may be pulled out to a desired length and intended position. Thereafter, the extension members 710b-c and/or 112e-h may be locked in place, ready to receive the additional solar panels 116c-d.

Further, in some example embodiments, the extension members 710b-c and 112e-h may be attached to the prefabricated solar racking 103 using a combination of the different above mentioned attaching mechanisms. For example, one extension chord member 710c and its corresponding purlins 112e-f may be attached to the proximal end 115 of the prefabricated solar racking chord member 110 using the slide-in mechanism, while the other extension chord member 710b and its corresponding purlins 112g-h may be attached to the distal end 117 of the prefabricated solar racking chord member 110 using the hinge mechanism. The above included example is not limiting and other example combinations may be used to attach the extension members to the prefabricated solar racking that allow the extension members to be retracted during transportation.

Furthermore, in some example embodiments, the operation of extending the prefabricated solar racking 103 using the extension members 710b-c and 112e-h in the slide-in and/or hinge method may be automated or mechanized using any appropriate technology such as hydraulic arms, robotic arm, gears, motor, etc., without departing from a broader scope of the present disclosure. Automating and mechanizing the extension operation may further reduce the need for owner manipulation once the portable solar power system is deployed at a site. Also, automating and mechanizing the extension operation may further reduce set-up work for the set-up crew, thereby, further reducing an installation time and cost incurred by the end user. In certain example embodiments, the system may be further improved by providing a capability for wirelessly controlling the automated and mechanized extension operation using a remote control. It is noted that preferably low power consumption technology may be used to automate or mechanize the extension operation to improve operation efficiency while reducing installation time and cost.

Even though FIGS. 1-8 illustrate portable solar power system having a fixed tilt angle, i.e., tilt angle that is not adjustable once set, in other example embodiments, the portable solar power system, particularly, the prefabricated solar racking and extension members may be configured to rotate on one or more axes to adjust a tilt angle of the solar panels based on a position of the sun to maximize output efficiency. Such portable solar power system where the tilt angle is adjustable will be described in greater detail below in association with FIGS. 9-11.

### Adjustable Tilt

Turning to FIG. 9, this figure illustrates an end view and a top view of yet another example portable solar power system that is rotatable using a gear mechanism, in accordance with example embodiments of the present disclosure. At the onset, it is noted that, apart from the obvious difference that the tilt angle of the solar power system of FIG. 9 is adjustable, the solar power system 900 of FIG. 9 may be different from the solar power systems 100 shown in FIGS. 1-8 in that the solar power system 900 of FIG. 9 does not use post members to support the chord members and purlins. Instead, the solar power system 900 of FIG. 9 provides support for the chord members and purlins using a gear system 901 and/or an A frame or inverted V frame 902.

As depicted in FIG. 9, the tiltable solar power system 900 may include a main support chord 904 that may span the length of the trailer frame and run parallel to the longitudinal beams (101c, 101d) of the trailer frame 101. Further, the main support chord 904 may pivotally terminate at its ends via a metal stud and bearings into an inverted two-legged V-frame support 902 (herein ‘inverted V-frame’). That is, the tiltable solar power system 900 may have at least two V-frames. The bottom end of the two legs 902a and 902b of the inverted V-frame 902 may be affixed to the trailer frame 101, while, the top end of the two legs 902a and 902b of the inverted V-frame 902 that intersect each other may be coupled to a respective end of the main support chord 904. In particular, the main support chord 904 may have a steel pin or axle protruding out of it and into and through the holes in the top end of the two support legs 902a and 902b. These holes in the top end of the two support legs 902a and 902b may include bearings which would allow the main support chord 904 to pivot or rotate as driven by the drives 901.

Further, the tiltable solar power system 900 may include a plurality of cross-member chords 906a and 906b that are attached to and extend substantially perpendicular from the main support chord 904 in opposite directions. Furthermore, the tiltable solar power system 900 may include a plurality of purlins 908 that are attached atop the plurality of cross-member chords 906a and 906b such that the plurality of purlins 908 are substantially perpendicular to the plurality of cross-member chords 906a and 906b and run parallel to each other, the main support chord 904, and to the longitudinal beams (101c, 101d) of the trailer frame 101. Additionally, the tiltable solar power system 900 may include solar panels 116 that are attached to the plurality of purlins 908.

Depending on the size of the tiltable solar power system 900, one or more drives 901 may be located between the two ends of the main support chord 904. In particular, each drive 901 may include one or more large gears 920 and one or more small gears 910. The large gear 920 may have a semi-circular shape that is flat at the top side. As depicted in FIG. 9, the top side of the large gear 920 that is flat may attach to or may have affixed to it the main support chord 904 and/or the cross-member chords (906a, 906b). That is, the cross-member chords (906a, 906b) attached to the main support chord 904, and the purlins 908 and solar panels 116 attached to the cross-member chords (906a, 906b) may rest on or are attached to the large gear 920. Further, the large gear 920 may rest on the small gear 910 which is attached to the trailer frame 101. The small gear 910 may be powered by an electrical motor to rotate the small gear 910, i.e., small gear drive via teeth, gears, sprockets, belts, chains, etc. As the small gear 910 rotates, it may turn the large gear 920, thereby causing the entire flat top of the large gear 920 to rotate. As the flat top of the large gear 920 rotates, the cross-member chords (906a, 906b) supported on the flat top of the large gear 920; and the purlins 908 and solar panels 116 attached to the cross-member chords (906a, 906b), and the main support chord 904 rotate as well. In other words, as the two gears turn, the cross-member chords (906a, 906b), the purlins 908, and the solar panels 116 may pivot/rotate about a pitch axis, i.e., an axis that axially passes through a point where the main support chord 904 and legs (902a, 902b) of the inverted V-frame 902 join, thereby adjusting a tilt angle of the solar panels 116.

Even though the present disclosure describes the drive system 901 as including the large gear 920 and the small gear 910, one of ordinary skill in the art can understand and appreciate that, in some example embodiments, the small gear 910 may be omitted and the electrical motor may drive the large gear 920 directly using belts, chains, pulleys, etc. Further, in some example embodiments, depending on the size of the tiltable solar power system 900, additional drives 901 and/or support frames (inverted V-frames 902) may be added to the tiltable solar power system 900 in between the two ends of the main support chord 904. Some of the drives 901, particularly, the small gear 910 of the drives 901, may be used in a support role. That is, in some example embodiments, the drives 901 and/or the support frames placed in between the two ends of the main support chord 904 may be used in a support role for weight bearing, wind load and support, and not necessarily for driving or adjusting the tilt angle. However, in other example embodiments, the additional drives 901 and/or the support frames placed in between the two ends of the main support chord 904 may be used for both support and drive purposes.

In certain example embodiments, the trailer frame 101 may be configured to accommodate the electric motor (not shown) that drives the gears 910 and/or 920. The electric motor may be driven by a battery that is accommodated on the trailer frame 101 and charged by the tiltable solar power system 900. In particular, the electric motor may be controlled by a computer driven control module that determines the speed at which the tilt angle may be adjusted. In one or more example embodiments, the rate or speed of rotation or the solar racking members (chords, and purlins) and in turn the rate of adjustment of solar panel's tilt angle may substantially match the sun's pace as it moves throughout the sky. In one example, the tiltable solar power system 900 will start each day with the solar panels 116 facing an easterly direction. Accordingly, the solar racking (chords and purlins) that supports the solar panels 116 may be rotated such that it is oriented substantially perpendicular to the ground 590. Thereafter, the solar racking (chords and purlins) that supports the solar panels 116 may be rotated based on the position of the sun such that at the end of the day the solar racking may be oriented substantially perpendicular to the ground 590 in a westerly direction. That is, at the end of the day, the tilt angle of the solar panels may be adjusted such that they faces a westerly direction. Furthermore, the position of the solar racking may be reset to the easterly direction for the next day. Additionally, the computer driven control module may cause the solar racking to assume a 180 degree profile if high winds are detected. Sensors for detection of the wind and other factors may be disposed on the trailer frame 101.

One of ordinary skill in the art can understand and appreciate that the two legs forming the inverted V-frame may be long enough to accommodate a rotation of the solar racking to a near vertical position. Even though the present disclosure describes the electric motor, the battery, and the sensors as being accommodated on the trailer frame, one of ordinary skill in the art can understand and appreciate that the trailer frame 101 may be configured to accommodate any other electrical or mechanical elements needed for the operation of the portable and/or tiltable solar power system without departing from a broader scope of the present disclosure. For example, the trailer frame may have grounding clips, wiring, control modules, inverters, batteries, GPS tracking units, combiner boxes, conduits for running electric wiring, capacitors, connectors, computers, tracking devices for tracking the sun, transmitters, anemometers, and any other appropriate electrical and mechanical equipment to harvest and transmit solar energy after having been converted to electrical energy.

Furthermore, even though the example embodiment illustrated in FIG. 9 does not show extension members, one of ordinary skill in the art can understand and appreciate that extension members may be attached to the solar racking (cross-member chords and purlins) of the tiltable solar power system 900 using metallic couplers, hinges, and/or slide-in mechanisms as described above in association with FIGS. 7 and 8. For example, extension chord members may be attached to the cross-member chords 906a and 906b to extend the solar racking of the tiltable solar power system 900 and additional purlins may be attached atop the extension chord members for receiving additional solar panels, thereby, increasing the power output of the tiltable solar power system 900. Alternatively, in another example, extension purlins and extension main support chord members may be attached to one end or both the ends of the purlins 908 and main support chord 904 to longitudinally extend the solar racking of the tiltable solar power system 900. The above mentioned example for extending the solar racking of the tiltable solar power system 900 is not limiting and the solar racking of the tiltable solar power system 900 may be extended in any desired direction without departing from a broader scope of the present disclosure.

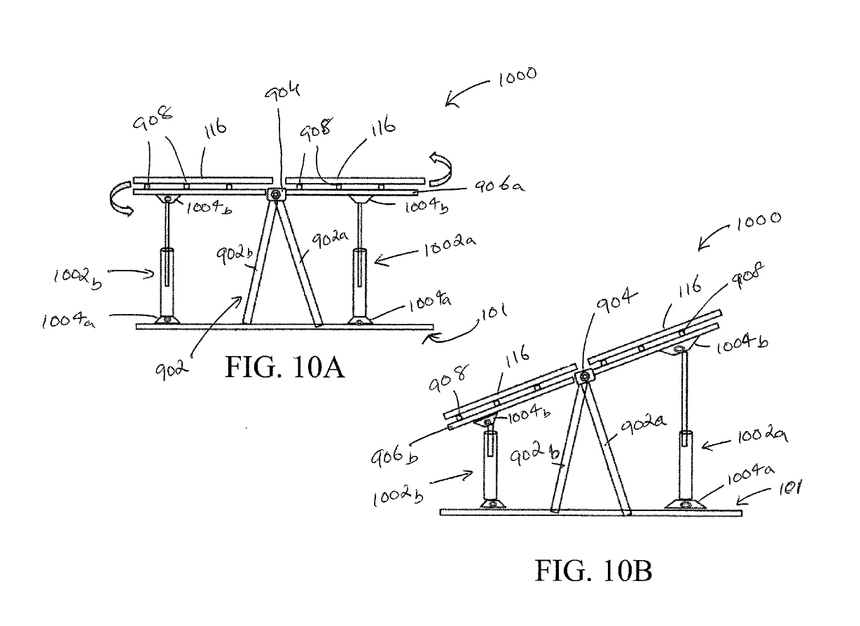

Turning now to FIG. 10, an alternative to the gear system for adjusting a tilt angle will be described below in greater detail. In particular, FIG. 10 illustrates another example portable solar power system that is rotatable using a hydraulic ram mechanism, in accordance with example embodiments of the present disclosure. As depicted in FIG. 10, the tiltable solar power system 1000 may include two sets of rams 1002a and 1002b controlled by hydraulic pumps that move them up or down to cause the solar racking and/or the solar panels supported by the solar racking to change its position relative to the sun. In particular, one set of rams 1002a are attached between the trailer frame 101 and the first set of cross-member chords 906a using one or more mounting members (1004a, 1004b), and the other set of rams 1002b are attached between the trailer frame 101 and the second set of cross-member chords 906b using one or more mounting members (1004a, 1004b). That is, one set of rams 1002a may support one set of cross-member chords 906a, the purlins 908 attached to the one cross-member chords 906a, and the solar panels 116 attached to the corresponding purlins, while the other set of rams 1002b may support the other set of cross-member chords 906b, the purlins 908 attached to the other set of cross-member chords 906b, and the solar panels 116 attached to the corresponding purlins.

In some example embodiments, similar to the post members 104 and 106 illustrated in FIGS. 1-8, each cross-member chord 906 of the tiltable solar powered system 1000 may be supported by a respective hydraulic-powered ram. However, on other example embodiments, similar to the drives 901 described above in association with FIG. 9, only the outer most set of cross-members chords (906a, 906b) may be supported by the hydraulic-powered rams (herein ‘rams’). In either case, as the rams 1002a and 1002b extend, the solar racking pivots/rotates about a pitch axis, i.e., an axis that axially passes through a point where the main support chord 904 and legs (902a, 902b) of the inverted V-frame 902 join, thereby adjusting a tilt angle of the solar panels 116 attached to the solar racking. The inverted V-frame 902 may be substantially similar to that described above in association with FIG. 9. Accordingly, the inverted V-frame 902 and its attachment to the main support chord 904 will not be repeated for sake of brevity. Further, the description of the solar panels 116 and solar racking, i.e., main support chord 904, the cross-member chords (906a, 906b), the purlins 908 is included above in association with the description of FIG. 9, and thus, will not be repeated herein for sake of brevity.

In particular, in FIG. 10A, the rams (1002a, 1002b) are equally extended, thereby, resulting in a horizontal orientation of the solar racking and the solar panels 116 supported by the solar racking. However, in FIG. 10B, one of the rams, i.e., ram 1002a may be extended and the other ram 1002b may be retracted resulting in tilted solar racking. In some example embodiments, the opposite rams may retract and extend till the solar racking is substantially vertically oriented. The two rams 1002a and 1002b may retract and extend simultaneously, i.e., they may operate in concert throughout the day, causing the solar panels to track the sun. In other words, the rams 1002a and 1002b operate in unison, keeping the solar panels flat (while rotating the solar racking) throughout the day as it tracks the sun.

Turning now to FIG. 11, this figure illustrates another example portable solar power system that is rotatable and has a single post racking assembly, in accordance with example embodiments of the present disclosure. As depicted in FIG. 11, the tiltable solar power system 1100 may include a single post member 1102 or one set of post members 1102 as compared to two sets of post members 104 and 106 in FIGS. 1-8. In particular, in the example tiltable solar power system illustrated in FIG. 11, a bottom end of the post member 1102 may be attached to the trailer frame 101 such that the post member 1102 extends vertically upwards from the trailer frame 101. Further, a tracking unit 1106 may be mounted to the top end of the post member 1102, and the solar racking (112 and 110, or 904, 906, and 908) and/or the solar panels 116 may be attached to the tracking unit 1106. The tracking unit 1106 may have a single or dual axis capability and may be configured to track the position of the sun and rotate the solar racking accordingly

Furthermore, additional support may be provided for the post members 1102 using one or more metallic support members 1104 that are attached to the trailer frame 101 on one end and the post member 1102 on the opposite end. The number and size of the supports may depend upon the height of the post member 1102, a size and weight of the solar racking (110, 112) with or without the extension members, and the solar panels 116. Additionally, extension members may be attached to the solar racking of the tiltable solar power system to receive and support additional solar panels as described above.

In certain example embodiments, the post member 1102 may be configured to further extend upwards in a telescopic fashion. Furthermore, even though the present disclosure describes the entire solar racking as being rotatable, in some example embodiments, one or more portions may be tiltable while a remainder portion remains fixed having a fixed tilt angle without departing from a broader scope of the present disclosure. Alternatively, as illustrated in FIG. 12, a single portable solar power system 1200 may include both a tiltable solar power unit 1100 (or 900 or 1000) and a fixed tilt solar power unit 100. That is, to increase efficiency, one or more fixed tilt solar power units may be used in combination with one or more tiltable solar power units. In particular, each solar power unit, i.e., the tiltable solar power unit 1100 (or 900 or 1000) and a fixed tilt solar power unit 100 may be connected together through electrical wiring harnesses and connectors. The electrical wiring harnesses and connectors may transmit the electrical energy from one unit to the other and may terminate into an inverter that may be coupled to a load.

Furthermore, as described above in association with the extension members, in some example embodiments, the tilt angle and/or the rotation of the solar racking may be wirelessly controlled by an owner using a remote control mechanism. That is, the owner may be able to manipulate the tilt angle and override an automatic tracking and rotation of the solar racking using the remote control, as desired.

Even though the present disclosure describes a rotation of the solar racking modules and the solar panels about a pitch axis, in other example embodiments, the solar racking and/or the solar panels of the tiltable solar power system may be rotatable about additional axes, such as the roll axis or yaw axis without departing from a broader scope of the present disclosure. For example, in one embodiment, the solar racking and/or the attached solar panels (both prefabricated and extension) may be configured to rotate or spin about the yaw axis, i.e., an axis that passes through a center (approximate center) of the trailer frame 101 and is normal to the trailer frame 101 (pointing towards the ground). In said embodiment, a trailer frame 101 of the portable solar power system 100 may be disposed on and coupled to a flat platform that is rotatable. In some examples, the rotatable flat platform may be attached to the trailer frame 101 at the deployment site. Alternatively, in other examples, the rotatable flat platform may be attached to the trailer frame at the factory. Further, in some examples, the flat platform may be a circular disc shaped platform having a diameter that approximately matches the width (distance between longitudinal beams (101c,101d)) of the trailer frame 101, whereas, in other examples, the flat platform may have any other appropriate shape without departing from a broader scope of the present disclosure.

In one example, the flat platform may be anchored to the ground 590 at its center via a vertical stationary pole (or any other appropriate structure) such that the flat platform may rotate about the vertical stationary pole. Further, at the center of the flat platform (i.e., adjacent to, within, or on top of the vertical stationary pole), there may be a large electric motor that operates in combination with an appropriate drive train or bevel gear configuration to rotate/turn the flat platform. Further, a plurality of rollers that work like large ball bearings may be optionally disposed under the rotatable flat platform, allowing the flat platform to smoothly turn around in a circle. In some examples, the flat platform may be configured to rotate in a full circle (360 degrees), while in other examples, the flat platform may be configured to rotate only half a circle (180 degrees).

Since the trailer frame 101 is coupled to the flat platform, when the flat platform rotates, the trailer frame 101 may also rotate along with the flat platform to maximize output efficiency of the portable solar power system. For example, in the morning the solar racking and the solar panels (prefabricated and/or extension) may be facing eastward. Further, during the day, the solar racking and the solar panels may be rotated based on rotation of the trailer frame via the rotation of the flat platform such that the solar racking and the solar panels may face westward at the end of the day, while the fixed tilt is maintained. In some examples, the solar racking and the solar panels may be rotated about the vertical stationary pole in addition to changing the tilt angle of the solar racking and/or the solar panels.

In addition to the rotatable flat platform, the portable solar power system 101 of said embodiment may further include one or more wheels that are coupled to the ends of the trailer frame 101 via support frames. For example, a top end (where legs converge) of an A-frame support/triangular support frame may be attached to each corner of the trailer frame 101. Further, wheels may be attached to the bottom end of each leg of each A-frame support, thereby resulting in eight wheels at the corners of the trailer frame 101 that rest on the ground 590 once the portable solar power system is set up at the deployment site. One of ordinary skill in the art can understand and appreciate that the wheels and support frames may be retractable or foldable to prevent any interference with transportation of the portable solar power system to the deployment site. Further, one of ordinary skill in the art can understand and appreciate that in other examples, the A-frame support may be replaced by or used in addition to any other appropriate support structure without departing from a broader scope of the present disclosure. Furthermore, even though the said example embodiment describes the trailer frame 101 having eight wheels, i.e., two wheels at each corner of the trailer frame, one of ordinary skill in the art can understand and appreciate that, in other example embodiments, lesser or more wheels and support frames may be used without departing from a broader scope of the present disclosure. For example, support frames and wheels may only be attached to one or two corners of the trailer frame 101. Further, in certain examples, each corner may have only one wheel instead of two. In some embodiments, support frames and wheels may be attached to any other portion of the trailer frame and/or the flat platform without departing from a broader scope of the present disclosure. For example, additional support frames and wheels may be attached to the outer cross-member beams (102a and 102c) of the trailer frame 101 and/or the perimeter of the flat platform.

In certain example embodiments, the wheels and the support frames may be configured to provide additional support and balance to the portable solar power system 100. However, in other example embodiments, the wheels and the support frames may be configured to further assist the rotation of the flat platform. For example, additional motors and/or drive systems may be coupled to the trailer frame 101 to drive the wheels at the corners of the trailer frame 101 individually or in unison. In yet another example embodiment, the flat platform may be rotated about a central axis (or vertical stationary pole) only based on the electrically/power driven wheels at the corners of the trailer frame. That is, the flat platform and thereby the trailer frame, the solar racking, and the solar panels may be rotated based on the central motor and drive system, the electrical/power driven wheels at the corners of the trailer frame 101, or a combination of both the central motor-drive system and the electrical/power driven wheels at the corners of the trailer frame 101.

In some examples of the embodiment where the rotation of the trailer frame is supported only by the electrically/power driven wheels, the portable solar power system may not include the rotatable flat platform. Instead, in said example, the trailer frame 101 may be directly anchored to the ground at the center and individually controlled electrically/power driven wheels may be attached to each corner of the trailer frame 101 as in the case of a holonomic drive train arrangement to rotate the trailer frame.

In order to account for uneven surfaces on which the portable solar power system may be deployed, the wheels and support frame of the trailer frame 101 may be provided with appropriate suspension and pivoting axle configurations. Alternatively, the flat platform may be configured to slightly pivot about the vertical stationary pole to compensate for uneven surfaces.

In some examples, the flat platform may include a ballast box to receive additional ballast, i.e., in addition to the ballast in the ballast boxes of the trailer frame 101, to provide additional stability to the portable power system. Further, to improve the stability of the portable solar power system of said example embodiment, the on-trailer computer based control system may be configured to: (a) position the solar racking such that a low end (near post 106) of the solar racking faces the wind and (b) stop the rotation of the flat platform.

One of ordinary skill in the art can understand and appreciate that the examples of extension members provided herein are not limiting and that the extension members can include any other appropriate member or device that extends the surface area of a prefabricated solar racking to receive any appropriate number of additional solar panels. That is, the extension members are not limited to extension purlins 112e-h, extension chords 710b-c, and/or support braces 704. In other examples, the extension members may include extension cross-member chords, extension main support chord, longer prefabricated purlins, longer prefabricated chords, support brace clips, mounting brackets, tracking units, additional post members, extension post members to further extend the height (length of each post), extension inverted V-frame members, additional inverted V-frame members, additional gears or hydraulic rams, etc. Furthermore, in some example embodiments, the extension members may be formed integral with the prefabricated racking.

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow. Further, the specification and drawings are to be regarded in an illustrative rather than a restrictive sense.

What is claimed is:

1. A portable solar power system comprising:
a solar racking configured on a trailer frame that is transportable to a deployment site,
wherein the solar racking comprises:
a plurality of post members, wherein a bottom end of each post member is attached to and extends substantially vertically upwards from the trailer frame,
a set of chord members, wherein each chord member of the set of chord members is coupled to a top end of one or more post members of the plurality post members, and
a plurality of purlins coupled to and disposed atop the set of chord members such that each purlin is substantially perpendicular to the set of chord members and parallel to other purlins of the plurality of purlins,
a set of solar panels disposed on and coupled to the plurality of purlins, wherein the set of solar panels are arranged in rows and columns; and
one or more extension members that are configured to be coupled to the solar racking at the deployment site to receive additional sets of solar panels.

2. The portable solar power system of claim 1:
wherein the solar racking is prefabricated, and
wherein the trailer frame comprises:
a pair of longitudinal beams and a pair of lateral beams that are arranged to form a substantially rectangle shaped outer frame; and
a plurality of cross-member beams that are disposed within the substantially rectangle shape outer frame such that they are parallel to each other and substantially perpendicular to the pair of longitudinal beams, wherein each cross-member beam extends between the pair of longitudinal beams.

3. The portable solar power system of claim 1, wherein the trailer frame comprises a plurality of levelling members that are integral with the trailer frame to permit level installation of the trailer frame at the deployment site.

4. The portable solar power system of claim 1, wherein the trailer frame comprises a plurality of removable levelling members that are detached from the trailer frame following a level installation of the trailer frame at the deployment site.

5. The portable solar power system of claim 1, wherein the plurality of post members include a first set of post members and a second set of post members, the first set of post members being taller than the second set of post members.

6. The portable solar power system of claim 1, wherein each chord member of the set of chord members is coupled to a top end of a post member of the first set of post members and a top end of a post member of the second set of post members.

7. The portable solar power system of claim 6, wherein a length of the first set of post members and a length of the second set of post members define a tilt angle of at least one of the set of solar panels and the additional set of solar panels.

8. The portable solar power system of claim 1, wherein the solar racking and the one or more extension members are stationary such that a tilt angle of the set of solar panels and the additional set of solar panels is fixed.

9. The portable solar power system of claim 1, wherein at least a portion of the solar racking is rotatable along one or more axes to adjust a tilt angle the set of solar panels and the additional set of solar panels is fixed based on a position of the sun.

10. The portable solar power system of claim 1, wherein the one or more extension members comprise: one or more extension chord members and one or more extension purlins.

11. The portable solar power system of claim 11:
wherein, at the deployment site, the one or more extension chord members are coupled to at least one of a proximal end and a distal end of one or more chord members of the set of chord members to extend a length of the one or more chords of the solar racking, and
wherein the one or more extension purlins are coupled to and disposed atop the one or more extension chord members such that each extension purlin is substantially perpendicular to the one or more extension chord members, and
wherein the additional sets of solar panels are coupled to the one or more extension purlins.

12. The portable solar power system of claim 1, wherein the one or more extension members are attached to solar racking using a hinge such that the one or more extension members swing pivotally about the hinge, wherein during transportation the one or more extension members are folded in and at the deployment site the one or more extension members are folded out to extend the solar racking.

13. A portable solar power system comprising:
a solar power unit comprising:
a solar racking configured on a trailer frame that is transportable to a deployment site,
wherein the solar racking comprises:
a set of chord members comprising a main support chord member and a plurality of cross-member chords that are coupled to the main support chord member and are substantially perpendicular to the main support chord member;
a plurality of purlins coupled to and disposed atop the plurality of cross-member chords such that each purlin is substantially perpendicular to plurality of cross-member chords and parallel to other purlins of the plurality of purlins,
a set of solar panels disposed on and coupled to the plurality of purlins, wherein the set of solar panels are arranged in rows and columns; and
one or more extension members that are configured to be coupled to the solar racking at the deployment site to receive additional sets of solar panels.

14. The portable solar system of claim 13, further comprising another solar power unit that is electrically coupled to the solar power unit, wherein the another solar power unit has another solar racking with a fixed tilt angle.

15. The portable solar power system of claim 13, further comprising a drive system that is coupled to the solar racking and configured to rotate at least one of the solar racking and the one or more extension members to adjust a tilt angle of the set of solar panels and the additional set of solar panels based on a position of the sun.

16. The portable solar power system of claim 13, further comprising at least two inverted V-frames, wherein the terminal ends of the main support chord member are pivotally coupled to a top end of each inverted V-frame, respectively, and wherein the bottom end of each inverted V-frame is coupled to the trailer frame.

17. The portable solar system of claim 15, wherein the drive system comprises:
a large gear that is substantially semi-circular in shape and having a flat end,
wherein the flat end of the large gear is attached to one or more of the plurality of cross-member chords and supports the solar racking; and
a small gear that is disposed below and supports the large gear.

18. The portable solar system of claim 17, wherein the small gear engages the larger gear and operate in unison to rotate the solar racking based on a position of the sun.

19. The portable solar system of claim 13, further comprising a plurality of rams that coupled to the solar racking and are controlled using hydraulic pumps to rotate at least one of the solar racking and the one or more extension members to adjust a tilt angle of the set of solar panels and the additional set of solar panels based on a position of the sun.

20. The portable solar system of claim 19, wherein a top end of each ram is coupled to one or more of the plurality of cross-member chords and a bottom end of each ram is coupled to the trailer frame, and wherein the rams extend and retract in unison to rotate the solar racking based on a position of the sun.
